(19) United States
(12) Patent Application Publication
(10) Pub. No.: US 2008/0260466 A1
(43) Pub. Date: Oct. 23, 2008

(54) Apparatus for permitting access to the interior of a subterranean fluid-carrying pipe by way of an excavation which has uncovered the wall of the pipe

(76) Inventor: David Alan Stone, Wiltshire (GB)

Correspondence Address: KEVIN W. GRIERSON;WILLCOX & SAVAGE, P.C., ONE COMMERCIAL PLACE, SUITE 1800, NORFOLK, VA, 23510, US

(21) Appl. No.: 12/148,147

(22) Filed: Apr. 17, 2008

Related U.S. Application Data
(60) Provisional application No. 60/912,709, filed on Apr. 19, 2007.

(51) Int. Cl. F16L 55/18

(52) U.S. Cl. 405/184.1

(57) ABSTRACT

Apparatus for permitting access to the interior of a fluid-carrying pipe, the apparatus comprising a valve assembly adapted to permit a hole to be drilled in the wall of the pipe or an item to be introduced into or removed from the pipe by way of a pre-existing hole in the wall of the pipe without fluid escaping from the assembly and a member which has a first end connected to the valve assembly and a second end for engaging that part of the wall of the pipe lying opposite the valve assembly, the member being adapted to be lowered into the excavation and then engaged with the wall of the pipe in such a manner that the valve assembly can be clamped to the wall of the pipe.

The present invention, which claims the benefit of provisional patent application No. 60/912,709, filed Apr. 19, 2007, relates to an apparatus for permitting access to the interior of a subterranean fluid-carrying pipe by way of an excavation that has uncovered the wall of the pipe.

### BACKGROUND OF THE INVENTION

Subterranean pipes carrying gas in particular, but also other fluids, need to be inspected internally from time to time to determine their condition. In addition, they may need to be repaired internally if a leak has been detected. This requires that access be obtained to the interior of the pipe. This is usually done by drilling a hole in the wall of the pipe after excavating a hole in the ground to uncover the wall of the pipe. Then a camera can be inserted into the interior of the pipe through the drilled hole for inspection purposes or a bagging off device can be inserted through the hole to cut off the flow of gas in one direction for repair purposes.

When drilling a hole in the wall of the pipe and during insertion of the camera, bagging off device or other item, it is important that any gas that is released during drilling or insertion does not find its way into the atmosphere. Consequently it is the norm to attach a valve assembly to the excavated wall of the pipe. The valve assembly usually comprises a ball valve (or a gate valve) which has a longitudinal hole in it which is aligned to face the wall of the pipe to permit a drill or other device to be passed through it and engage the wall of the pipe or where there is a pre-existing hole drilled in the wall of the pipe through the hole and into the interior of the pipe. The valve assembly is also provided with an annular seal through which the drill or other device is inserted and which forms a seal with the drill or other device when these are inserted through the valve. Consequently, any gas released from the pipe during the operation is prevented from escaping from the valve and into the atmosphere. When the drill or device has been removed, the ball valve is closed by rotating or moving the valve hole out of alignment with the hole in the pipe to prevent gas release.

After an excavation has been performed to uncover the wall of the pipe, valve assemblies of the type defined are usually attached to the wall of the pipe by means of a chain which is attached at one end to the assembly. The chain is then wrapped tightly around the wall of the pipe and then attached to another end of the assembly.

It is the current practice to excavate holes which are of as small a diameter as possible, so as to reduce traffic disruption where the gas pipe is located in a busy street and to reduce reinstatement costs and subsequent care of the road surface. In this case a special machine cuts out a cylindrical coupon of material from above the pipe. After operations the coupon is then replaced to minimise or obviate reinstatement.

With the reduction in the diameter of the excavations and the increased depths of excavations it is proving impossible to use the current chain-type of attachment or clamp to clamp or attach the assembly to the pipe, because such attachments need more space and clearance than is available for an operator to wrap the chain around the wall of the pipe.

Accordingly it is an object of the present invention to overcome this disadvantage.

### SUMMARY OF THE INVENTION

According to the present invention, we provide an apparatus for permitting access to the interior of a subterranean fluid-carrying pipe by way of an excavation which has uncovered the wall of the pipe, the apparatus comprising a (1) valve assembly adapted to permit a hole to be drilled in the wall of the pipe or an item to be introduced into or removed from the pipe by way of a pre-existing hole without fluid escaping from the assembly and (2) a member which has a first end connected to the valve assembly and a second end for engaging that part of the wall of the pipe, in use, normally lying opposite the valve assembly, the member being adapted to be lowered into the excavation and then engaged with the wall of the pipe in such a manner that the valve assembly can be clamped to the wall of the pipe.

Preferably the member is in the form of a hook having a first end connected to the valve assembly and the second end for hooking round the wall of the pipe.

The valve assembly comprises a saddle for mounting the valve assembly on to the wall of the pipe, the saddle being adapted to form a seal with the wall of the pipe, and the member being adapted to attach the saddle to and release the saddle from the wall of the pipe.

The assembly further comprises a jacking stem engagable with the saddle, the jacking stem, in use, being movable to move the saddle into and out of engagement with the wall of the pipe.

Preferably the valve assembly comprises a ball valve and a housing for the ball valve, the ball valve being movable within the housing to permit a longitudinal hole in the ball valve to be aligned with the wall of the pipe whereby a drill may be passed through the hole in the ball valve to engage the wall of the pipe or another item may be passed through the hole in the ball valve and into the pipe through a pre-existing hole in the wall of the pipe, the ball valve, after use, being movable in the housing to a position where the hole is obscured from the wall of the pipe to prevent fluid escaping from the ball valve.

Suitably the housing of the ball valve is engagable with the jacking stem, the housing, in use, being movable to cause corresponding movement of the jacking stem and as a consequence movement of the saddle.

The first end of the member comprises a boss within which the saddle and jacking stem are movable.

Preferably the boss is connected to the jacking stem in such a way that as the jacking stem is moved towards the saddle to cause it to engage with the wall of the pipe, the second end of the member is caused to engage with the wall of the pipe.

Preferably, the ball valve housing is provided with a flange to permit the housing to be moved towards and away from the saddle by means of a tool which, in use, is engagable with the flange.

### BRIEF DESCRIPTION OF THE DRAWINGS

An embodiment of the present invention will now be particularly described with reference to the drawings in which:

FIG. 1 is a view of the valve assembly and clamping member, partly in section before the member is attached to the wall of the pipe,

FIG. 2 is a further view of the valve assembly and clamping member when clamped to the pipe, and

FIG. 3 is a further view of the valve assembly and clamping member in position to receive a camera assembly.

### DETAILED DESCRIPTION OF THE INVENTION

Referring to the drawings the apparatus comprises a valve assembly 1 and clamping member 2.

The valve assembly 1 comprises a generally cylindrical saddle 3 for mounting on the wall 4 of the pipe 5, a generally cylindrical jacking stem 6 engaged with the saddle 3 and a ball valve 7 retained within a generally cylindrical housing 8, which engages with the jacking stem 6.

The clamping member 2 has a first end or portion in the form of a generally cylindrical boss 9 connected to the saddle 3 and a second end or portion in the form of a hook or letter “G” 10 for engaging the wall 4 of the pipe 5. The walls of the hook 10 may be flat for purposes to be described.

The saddle 3 has a lower end for engaging the pipe wall 4 and is shaped to conform to the shape of the pipe wall 4. The lower end of the saddle 3 is provided with a resilient seal 11, e.g., of rubber, which conforms with the shape of the pipe wall 4 in that area and this enables the saddle 3 when urged towards and engaging the pipe wall 4 to form a seal with the pipe wall 4.

The saddle 3 is received within and is able to move along the boss 9 which has an internal recess 12 forming an annular clearance 13 on one side with the saddle 3. The saddle 3 is provided with an O-ring 14 which engages with an internal wall 15 of the boss 9 in such a way as to prevent the saddle 3 progressing downwardly only under the effect of gravity.

The jacking stem 6 has a lowermost surface which engages with the uppermost surface of the saddle 3. An O-ring 16 is disposed in a recess in the uppermost surface of the saddle 3 so that the stem 6 and the saddle 3 form a seal with each other. The saddle 3 has a radially outwardly projecting pin 17 which projects into the annular clearance 14 and serves to guide movement of the saddle 3. The jacking stem 6 is externally threaded with a male thread 18 and this engages with an internally threaded female portion 19 on an upper portion of the boss 9.

The ball valve 7 is of conventional design and comprises a ball 20 rotatably housed within the housing 8. While not shown the ball 20 has a longitudinal hole extending through it which is configured to permit the passage therethrough of various items such as drills, cameras, stopping off bags and the like. While not shown when ball 20 is rotated so that the hole is aligned to face the pipe wall 4, a drill or other items may be passed through the ball 20 to engage with the pipe wall 10 or enter it where a hole has already been drilled. Otherwise, the ball 20 can be rotated so that the hole is obscured by the wall of the housing 8. Instead of a ball valve a gate valve could be used.

The upper end of the jacking stem 6 is provided with an externally threaded neck 21 which is engaged by the internally threaded portion 22 of the housing 8, the end of the portion engaging the shoulder formed by the neck 21 and body of the jacking stem 6.

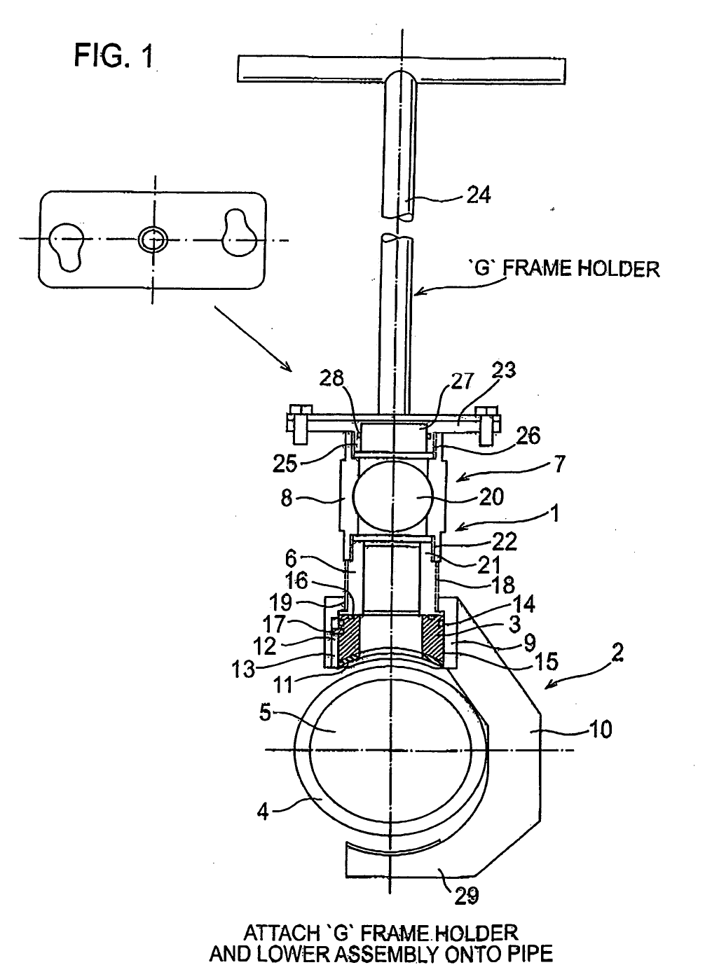

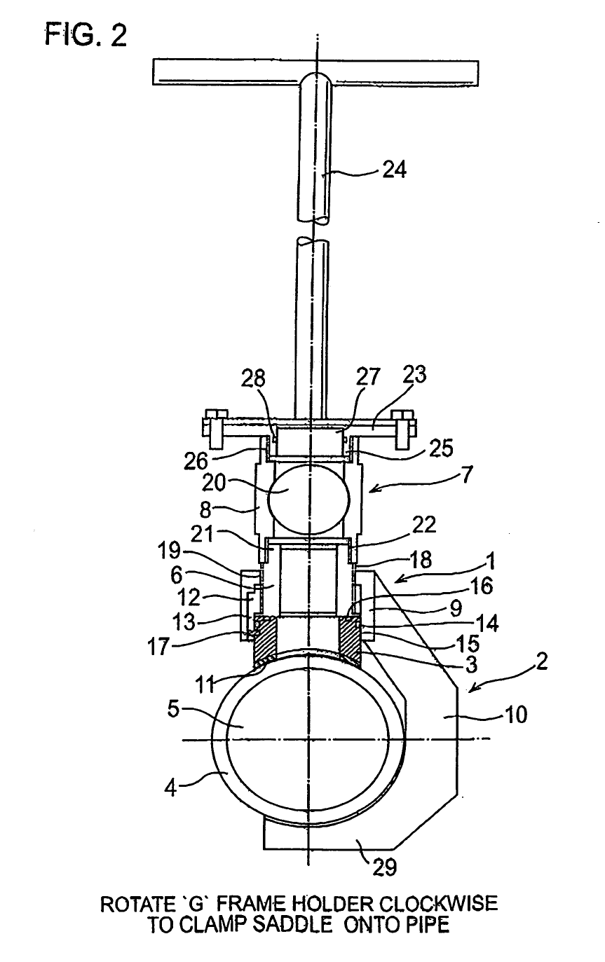

A top flange member 23 is provided for screwing the housing 8 downwardly when the flange member 23 is rotated by a tool such as the long handled box spanner 24 shown in FIGS. 1 and 2. The flange member 23 has a central cylindrical section 25 which is externally threaded to engage with an internally threaded uppermost portion 26 of the housing 8. The central cylindrical section 25 also has a hexagonal internal wall 27 for engagement with a hexagonal end (not shown) of the spanner 24, whereby the spanner 24 can rotate the flange member 23. The central cylindrical section 25 of the flange member 23 has an annular recess in its internal wall which houses an annular seal 28 which forms a seal with a drill or other device when this is introduced through the valve, jacking stem and saddle into engagement with or into the internal bore of the pipe to prevent the escape of gas.

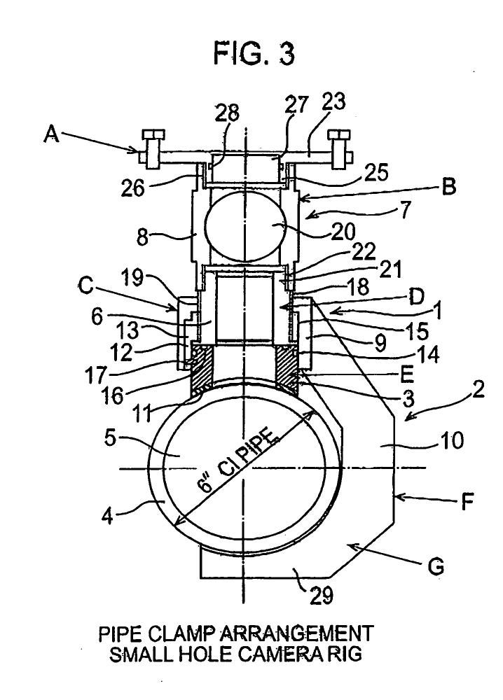

In use, after the excavation has been made to enable the external wall 4 of the pipe 5 to be accessed for drilling and other purposes, the valve assembly 1 and clamping member 2 are lowered into the hole with the axis of the hook part 10 parallel to the axis of the pipe wall 4 so that a flat side of the hook 10 lies against the pipe wall (not shown). Then the hook part 10 is then rotated by approximately 90° to the position shown in FIG. 1 with the lowermost part 29 of the hook part 10 located underneath, but spaced from the underneath of the pipe wall 4. Next, the end of the spanner 24 is inserted into the hexagonal internal wall 27 of the flange member 23 and the flange member 23 is rotated to cause the flange member 23 to move downwardly. This causes the valve housing 8, jacking stem 6 and saddle 3 to be rotated and to move downwardly. The saddle 3 is then caused to engage and form a seal with the pipe wall 4 as shown in FIG. 2. At the same time the rotation of the jacking stem 6 to move it downwards causes the lowermost portion 29 of the hook part 10 to be moved upwardly and grip and clamp the valve assembly 1 to the pipe wall 4 as shown in FIGS. 2 and 3 due to the female thread 19 on the boss 9 and the male thread 18 on the jacking stem 6 causing these components to move in opposite directions. The valve assembly 1 is now in place and the ball valve 7 may be opened to permit a drill to be inserted through the apparatus, engage the pipe wall and drill a hole in the wall of the pipe or where a hole has already been drilled permit the passage of equipment such as a camera, stopping off bag or other items. Alternatively, after a job has been completed, the assembly may be used to lower a plug or seal into the excavation to plug or seal the hole in the pipe wall. All these operations can be carried out in so called “no gas” conditions, i.e., without gas escaping from the valve assembly and into the environment. Disassembly and removal of the apparatus is the reverse of the procedure described.

What is claimed:

1. Apparatus for permitting access to the interior of a fluid-carrying pipe, the apparatus comprising a valve assembly adapted to permit a hole to be drilled in the wall of the pipe or an item to be introduced into or removed from the pipe by way of a pre-existing hole in the wall of the pipe without fluid escaping from the assembly and a member which has a first end connected to the valve assembly and a second end for engaging that part of the wall of the pipe lying opposite the valve assembly, the member being adapted to be lowered into the excavation and then engaged with the wall of the pipe in such a manner that the valve assembly can be clamped to the wall of the pipe.

2. Apparatus as claimed in claim 1 in which the member is in the form of a hook having a first end connected to the valve assembly and a second end for hooking round the wall of the pipe.

3. Apparatus as claimed in claim 1 in which the valve assembly comprises a saddle for mounting the valve assembly on the wall of the pipe, the saddle being adapted to form a seal with the wall of the pipe and the member being adapted to attach the saddle to and release the saddle from the wall of the pipe.

4. Apparatus as claimed in claim 1 in which the assembly further comprises a jacking stem engagable with the saddle, the jacking stem, in use, being movable to move the saddle so that it engages with the wall of the pipe.

5. Apparatus as claimed in claim 1 in which the valve assembly comprises a ball valve and a housing for the ball valve, the ball valve being movable within the housing to permit a longitudinal hole in the ball valve to be aligned with the wall of the pipe whereby a drill may be passed through the hole to engage the pipe wall or another item may be passed through the hole in the ball valve and into the pipe through a pre-existing hole in the wall of the pipe, the ball valve being movable in the housing to a position where the hole is obscured from the wall of the pipe to prevent fluid escaping from the ball valve.

6. Apparatus as claimed in claim 5 in which the housing of the ball valve is engagable with the jacking stem, the housing being movable to cause corresponding movement of the jacking stem whereby to cause the saddle to move into and out of engagement with the wall of the pipe.

7. Apparatus as claimed in claim 4 in which the first end of the member comprises a boss within which the saddle and jacking stem are movable.

8. Apparatus as claimed in claim 7 in which the boss is connected to the jacking stem in such a way that as the jacking stem is moved towards the saddle to cause it to engage with the wall of the pipe, the second end of the member is caused to engage with the wall of the pipe.

9. Apparatus as claimed in claim 5 in which the ball valve housing is provided with a flange to permit the housing to be moved towards and away from the saddle by means of a tool which is engagable with the flange.
